(19) United States
(12) Patent Application Publication
(10) Pub. No.: US 2024/0017681 A1
(43) Pub. Date: Jan. 18, 2024

(54) PAD OR COVER SYSTEMS FOR TRUCK TAILGATES AND THE LIKE

(71) Applicant: N.B. Adventures LLC d.b.a. BillieBars, Wyomissing, PA (US)

(72) Inventors: William H. Kiefer, IV, Elizabethtown, PA (US); Nathan T. Sutherland, Wyomissing, PA (US)

(73) Assignee: N.B. Adventures LLC d.b.a. BillieBars, Wyomissing, PA (US)

(21) Appl. No.: 17/865,901

(22) Filed: Jul. 15, 2022

(51) Int. Cl. B60R 13/01

(52) U.S. Cl. CPC B60R 13/01; B60R 2013/016

(57) ABSTRACT

According to some illustrative embodiments, a novel and advantageous vehicle tailgate cover and/or pad system is provided. In the preferred embodiments, the vehicle tailgate cover and/or pad system is uniquely configured to provide a vehicle tailgate with a flat and padded surface. In some preferred embodiments, the vehicle tailgate cover system is fixed to a vehicle tailgate and has a base of rigid material, the base having a front surface that is substantially flat, and the base including at least one mounting through-hole for mounting the vehicle tailgate cover system to the vehicle tailgate with fasteners, and a padding layer attached to the base at the front surface of the base.

### BACKGROUND

The present invention relates to systems and methods for providing a pad or cover for vehicle tailgates, and the preferred embodiments relate to systems and methods for providing a pad or cover for truck tailgates and the like.

Existing truck tailgate covers are provided with a hard material such as metal or plastic having ridges. Considerable discomfort and sometimes injuries are caused with existing tailgates when kneeling on the tailgate to reach into the bed of the truck. Accordingly, existing truck tailgates make it difficult, uncomfortable, and painful to maneuver on the tailgate and access the bed. Moreover, due to, e.g., ridges in the tailgate, placing drinks on existing tailgates can be unstable causing spills.

The preferred embodiments of the present invention overcome shortcomings of the above and/or other background art.

### SUMMARY

As indicated above, the preferred embodiments overcome shortcomings in the above and/or other background art.

In some preferred embodiments, a vehicle tailgate cover and/or pad system is configured in a manner that provides a safe and comfortable platform for a user to kneel or sit on to, e.g., access a vehicle bed. The vehicle tailgate cover and/or pad system provides a flat and padded surface. The vehicle tailgate cover also provides a working surface on the tailgate.

According to some embodiments, a vehicle tailgate cover system is provided that includes: a base of rigid material, the base having a front surface that is substantially flat, and the base including at least one mounting through-hole for mounting the vehicle tailgate cover system to a vehicle tailgate with fasteners, and a padding layer attached to the base at the front surface of the base.

In some preferred embodiments, the padding layer includes at least one through-hole and the at least one through hole of the padding layer is aligned with the least at least one mounting through-hole of the base.

In some preferred embodiments, at least one of the at least one mounting through-hole of the base is located at an edge of the base, and the edge of the base is not covered by the padding layer to allow for fastening of the base between a lip of the vehicle tailgate and the vehicle tailgate.

In some preferred embodiments, the vehicle tailgate cover system further includes a notch formed in the base and padding layer for allowing exposure of a component of the tailgate.

In some preferred embodiments, the padding layer is attached to the base with an adhesive.

In some preferred embodiments, the vehicle tailgate cover system further includes a cup holder through-hole extending through the padding layer and the base, and a cup holder fitted in the cup holder through-hole.

In some preferred embodiments, the base has a thickness of about ⅛ inch to about ¾ inch. In some preferred embodiments, the padding layer has a thickness of about 1/16 inch to about 1 inch.

In some preferred embodiments, the base is made of a material selected from the group consisting of metal, plastic, polymer, fiberglass, and combinations thereof. In some preferred embodiments, the base is made of a material selected from the group consisting of aluminum, steel, stainless steel, and combinations thereof.

In some preferred embodiments, the padding layer is made of material selected from the group consisting of foam, rubber, polymer, and combinations thereof. In some preferred embodiments, the padding layer is made of cross-linked polyethylene or marine-grade foam.

In some preferred embodiments, the padding layer is in multiple pieces attached to the base.

In some preferred embodiments, the padding layer includes a portion of reduced thickness at an edge for allowing closure of the tailgate.

According to some other embodiments a method of making a vehicle tailgate cover system includes: providing a base of rigid material, the base having a front surface that is substantially flat, and the base having at least one mounting through-hole for mounting the vehicle tailgate cover system to a vehicle tailgate with fasteners, providing a padding layer, and attaching the padding layer to the base at the front surface of the base.

According to some other embodiments of the invention, a method of using the vehicle tailgate cover system is provided that includes: aligning the at least one mounting through-hole of the base with mounting holes in a vehicle tailgate, and fastening the vehicle tailgate cover system to the vehicle tailgate using fasteners inserted in the mounting through-holes of the base and the mounting holes of the vehicle tailgate.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWINGS

The preferred embodiments of the present invention are shown by way of example, and not limitation, in the accompanying figures, in which:

FIG. 1 is perspective view of a vehicle tailgate cover system according to some embodiments of the invention.

FIG. 2 is an illustrative picture of an exemplary embodiment of the present invention demonstrating the tailgate cover system installed to a truck tailgate.

FIG. 3 is a cross-section view of a tailgate cover system according to some preferred embodiments.

FIG. 4A is a front plan view of a base of the tailgate cover system in some embodiments of the invention. FIG. 4B is a side view of the base of the tailgate cover system according to some embodiments of the invention.

FIG. 5 is a front plan view of a base of the tailgate cover system in some embodiments of the invention.

FIG. 6A is a front plan view of a padding layer of the tailgate cover system in some embodiments of the invention. FIG. 6B is a side view of a padding layer of the tailgate cover system in some embodiments.

FIG. 7 is a front plan view of a padding layer of the tailgate cover system in some embodiments of the invention.

FIG. 8. is a front plan view of a padding layer of the tailgate cover system in some embodiments of the invention.

FIG. 9 is an illustrative picture of an exemplary embodiment of the present invention demonstrating the tailgate cover system installed to a truck tailgate.

### DETAILED DESCRIPTION OF THE PREFERRED EMBODIMENTS OF THE INVENTION

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

### Illustrative Sizes, Dimensions & Scale in Some Embodiments

Although sizes and dimensions of the preferred embodiments can be varied as desired in various embodiments and implementations of the present invention, in some embodiments, the attached figures show illustrative embodiments with the elements illustrated to scale in size and dimensions.

### The Preferred Embodiments

The preferred embodiments provide a novel and advantageous vehicle tailgate cover and/or pad system that overcomes drawbacks of background devices. In the preferred embodiments, a vehicle tailgate cover and/or pad system is configured to provide a safe and comfortable platform for a user to kneel or sit on to, e.g., access a vehicle bed. The vehicle tailgate cover and/or pad system provides a flat and padded surface.

In preferred embodiments, the vehicle tailgate cover and/or pad system is provided as an after-market accessory that is added to a vehicle by a user of the vehicle. In the preferred embodiments, the user can remove and/or replace the tailgate cover and/or pad system as desired.

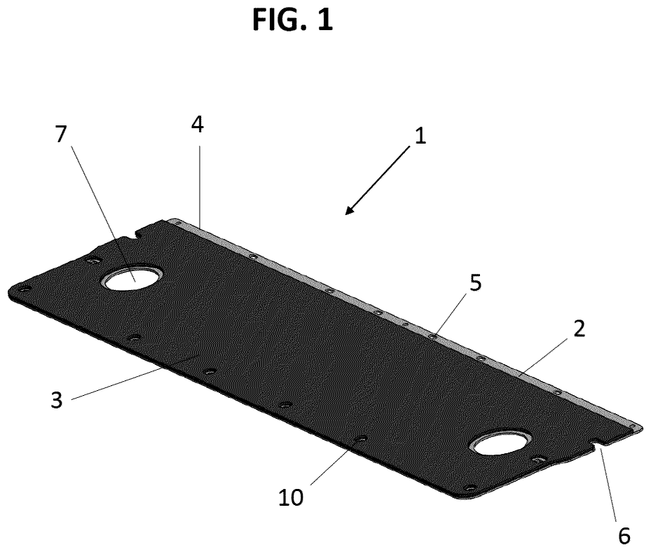

FIG. 1 is a perspective view of a tailgate cover system 1 according to an embodiment of the invention. The tailgate cover system 1 shown in FIG. 1 includes a base 2 and a padding layer 3 attached to the base 2. The base 2 has a flat plate or flat panel shape with substantially flat front and back surfaces.

As seen in FIG. 1, the padding layer 3 covers the base 2. Portions of the base 2 may not be covered by padding layer 3 depending on the specifications of the tailgate. FIG. 1 shows an uncovered strip 4 of the base 2. In some embodiments, the uncovered strip 4 of base 2 is formed so that the pad system can be installed between a vehicle tailgate and a lip of the vehicle tailgate. The tailgate cover system includes through-holes in base 2 which are used for mounting the tailgate cover system to a tailgate with, e.g., screws and/or other similar fasteners. In FIG. 1, through-holes 5 can be seen in the uncovered strip 4. In some embodiments, the padding layer 3 also includes through-holes which align with through-holes 5 in base 2. FIG. 1 also shows notches 6 in the tailgate cover system. Notches 6 in the tailgate cover system allow the tailgate cover system to fit around or allow exposure of various components of the tailgate such as hardware, latches, etc. in the tailgate depending on the specifications of the tailgate. In some embodiments, the tailgate cover system may also include a through-hole 7 for inserting a cup holder.

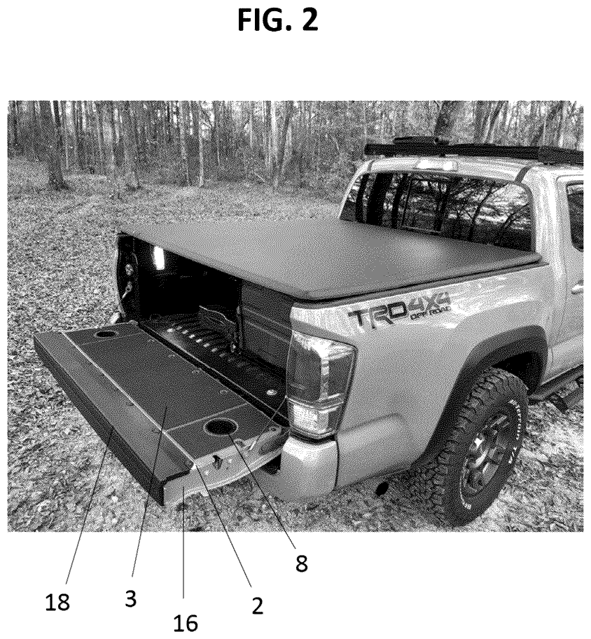

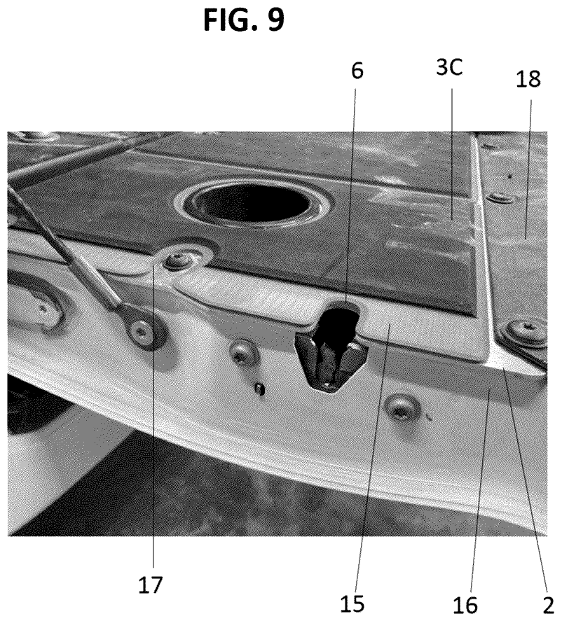

FIG. 2 shows one embodiment of a tailgate cover system installed on a tailgate of a truck. In FIG. 2, the tailgate cover system is attached to the tailgate by fasteners. The tailgate cover system in FIG. 2 includes a cup holder 8 installed in through-hole 7. FIG. 9 shows another embodiment of the tailgate cover system installed on a truck tailgate. FIG. 9 shows a notch 6 formed in the pad system to expose a latch in the tailgate. FIG. 9 also shows a base 2 installed between the lip 18 of the tailgate and the tailgate 16 at a portion of the base 2 that is not covered by the padding layer.

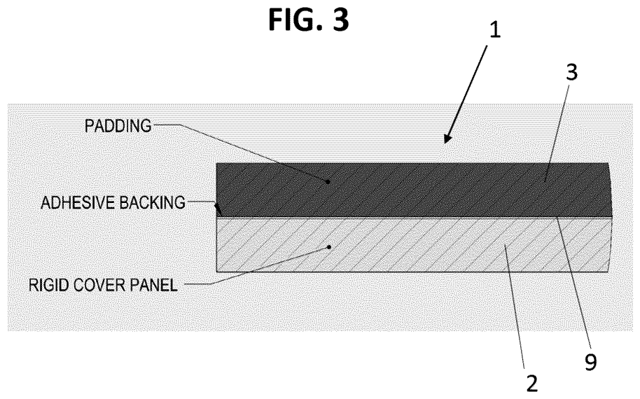

FIG. 3 is a cross-section view of an embodiment of the tailgate cover system. FIG. 3 shows pad 3 attached to base 2 by an adhesive 9. While FIG. 3 shows one padding layer, in some embodiments, the tailgate cover system may include more than one padding layer. In some embodiments, the padding layer 3 can have layers of different color tone. For example, FIG. 9 shows the padding layer having a layer of black color tone on top of a layer of grey color tone.

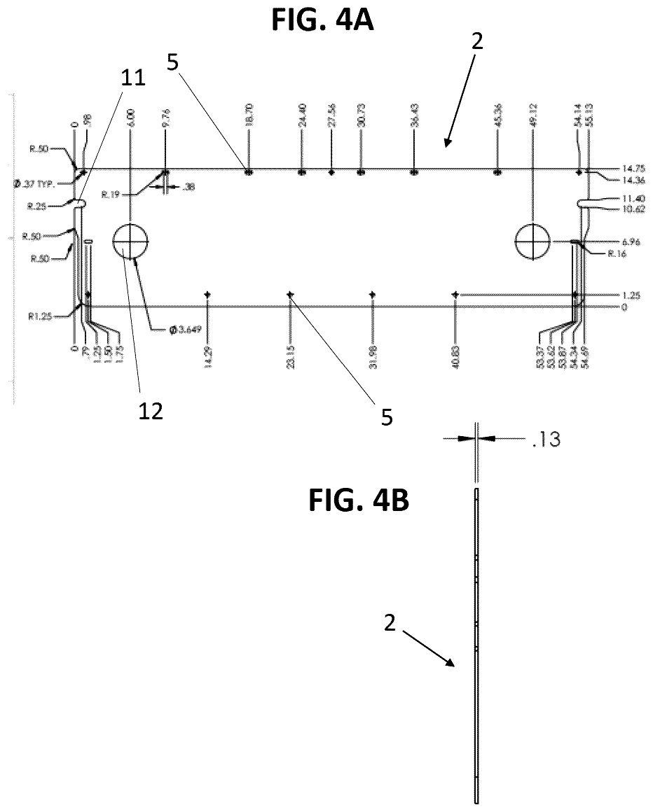

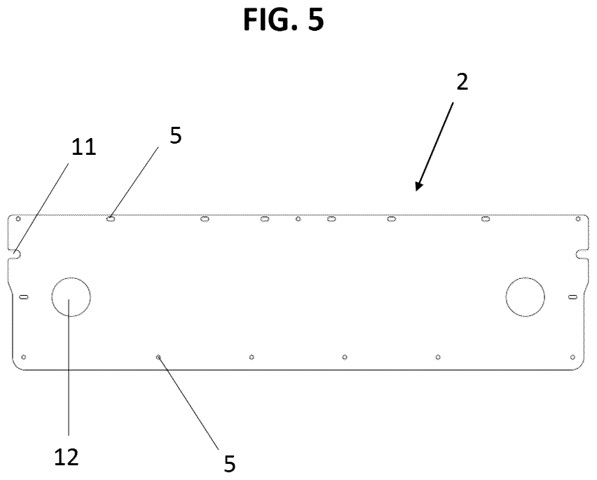

The base is a rigid cover panel and can be any rigid material such as metal, plastic, polymer, fiberglass, etc. In some embodiments, the base can be of a metal material such as aluminum, steel or stainless steel. FIGS. 4A and 5 provide a front plan view of base 2. FIGS. 4A and 5 show through-holes 5, notch 11 and through-hole 12. Notch 11 and through-hole 12 in base 2 correspond to and form notch 6 and through-hole 7, respectively, in the tailgate cover system 1 as shown in FIG. 1. The thickness of the base is at least ⅛ inch. Preferably the thickness of the base is at least ⅙ inch. More preferably the thickness of the base is at least ¼ inch. The thickness of the base is at most ¾ inch. Preferably the thickness of the base is at most ⅝ inch. More preferably the thickness of the base is at most ½ inch.

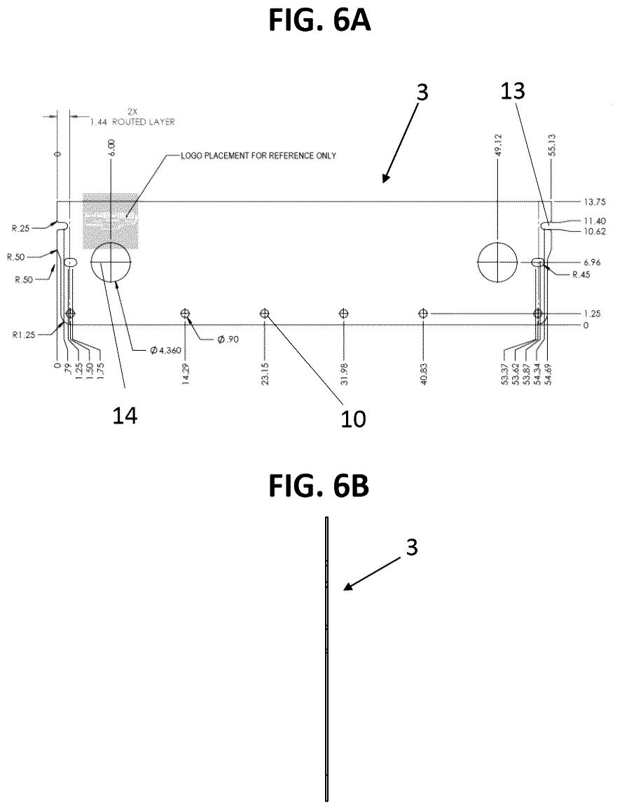

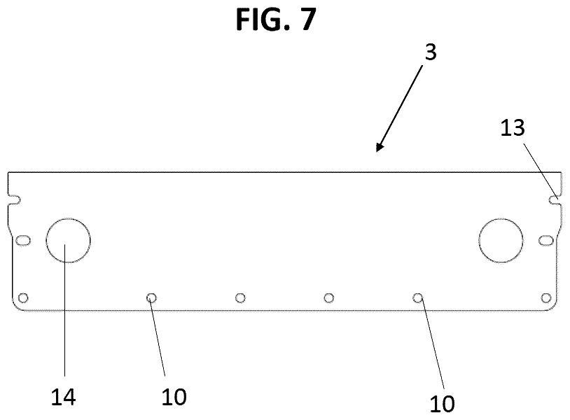

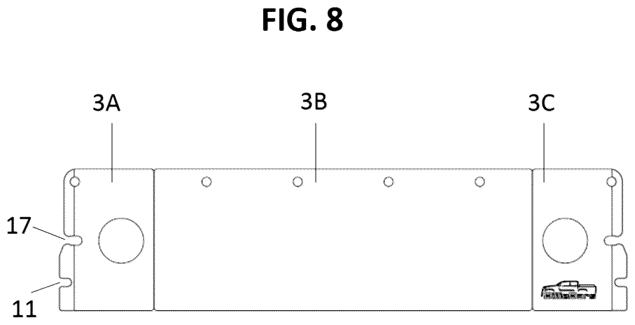

FIGS. 6A and 7 provide a front plan view of an embodiment of the padding layer 3 of pad system 1. FIGS. 6 and 7 show through-holes 10, notch 13 and through hole 14. Through-holes 10 in padding layer 3 allow for access to through-holes 5 in base 2 for inserting fasteners to attach the tailgate cover system to a vehicle tailgate. Notch 13 and through-hole 14 in padding layer 3 correspond to and form notch 6 and through-hole 7, respectively, in the tailgate cover system 1 as shown in FIG. 1. Padding layer 3 may also include cut-out portions 17 for allowing access to through-holes 5 in base 2 for inserting fasteners. Cut-out portions 17 are shown in FIGS. 8 and 9. Padding layer 3 can be made of any open or closed cell foam, rubber, or soft polymer. For example, in some embodiments, padding layer 3 can be made of cross-linked polyethylene or marine-grade foam. The thickness of the padding layer is at least 1/16 inch. Preferably the thickness of the padding layer is at least ⅛ inch. More preferably, the thickness of the padding layer is at least ⅜ inch. The thickness of the padding layer is at most 1 inch. Preferably the thickness of the padding layer is at most ¾ inch. More preferably the thickness of the padding layer is at most ⅝ inch.

The padding layer 3 shown in FIGS. 1, 6 and 7 is in one piece. In an alternative embodiment, the padding layer can be in multiple pieces. As shown in FIG. 8, the padding layer is in three pieces (3A, 3B, 3C). FIG. 2 also shows the padding layer in multiple pieces. The padding layer can be cut, e.g. by routing, into multiple pieces to provide a custom fit with the tailgate.

In some embodiments, the padding layer 3 can have portions having a reduced thickness as compared to the rest of the padding layer. For example, as shown in FIG. 9, portion 15 of piece 3C of the padding layer has a reduced thickness. The reduced thickness of portion 15 of padding layer 3 as shown in FIG. 9 allows for properly closing and latching the tailgate. Portion 15 of padding layer 3 having a reduced thickness can be formed by, e.g., a milling process.

The adhesive layer can be any adhesive that provides a strong bond between the base and the padding layer and the adhesive used depends on the materials of the base and the padding layer. In preferred embodiments, the adhesive is applied to the padding layer with a removable protective film. The padding layer is attached to the base by removing the protective film from the adhesive on the padding layer and applying the padding layer with the exposed adhesive onto the base.

In preferred embodiments, the tailgate cover system can be formed by providing a base 2 of rigid material as shown, for example, in FIG. 5 that is shaped for a tailgate and having through-holes 5 for mounting to a tailgate; providing a padding layer 3 as shown, for example, in FIG. 7 that is substantially shaped to match the shape of the base 2 and/or can be cut into pieces that can be arranged to substantially match the shape of the base and having through-holes 10 for providing access to through-holes 5 of the base 2. Next, the one or more padding layers 3 are attached to the base 2 such that the shape of the padding layer 3 corresponds with the shape of the base 2 and through-holes 10 of padding layer 3 align with through holes 5 of base 2. The attachment of the padding layer 3 to base 2 can be, e.g., by way of an adhesive 9 as shown in FIG. 3. In preferred embodiments, the adhesive can be an adhesive backing layer that is attached to padding layer 3 prior to attaching the padding layer 3 to base 2, and the padding layer 3 is attached to be base 2 by placing the padding layer 3 with the adhesive backing layer 9 on the base 2.

In preferred embodiments, the tailgate cover system is designed such that through-holes 5 of the base 2 and through-holes 10 of the padding layer 3 can be aligned with existing mounting holes in a tailgate so that drilling in the tailgate is not necessary. In some preferred embodiments, the tailgate cover system is installed by removing the existing/factory tailgate cover, aligning through-holes 5 of the tailgate cover system of the present invention with mounting holes in the tailgate, and attaching the tailgate cover system of the present invention to the tailgate with fasteners via through-holes 5 and mounting holes in the tailgate. In preferred embodiments, upon removal of the existing/factory tailgate cover, the hardware used for fastening the existing/factor tailgate cover can be used to install the tailgate cover system of the present invention.

In some preferred embodiments, the tailgate cover system can be installed over an existing/factory tailgate cover. In this embodiment, the tailgate cover system is installed by removing the fasteners for the existing tailgate cover, aligning through-holes 5 of the tailgate cover system of the present invention with mounting holes of the existing/factory tailgate cover and with mounting holes in the tailgate, and attaching the tailgate cover system of the present invention to the existing/factory tailgate cover and tailgate with fasteners via through-holes 5 and mounting holes of the existing/factory tailgate cover and the tailgate.

In some embodiments, such as with some older or larger trucks, small holes may need to be predrilled in the tailgate for mounting the tailgate cover system to the tailgate. In the predrilled holes, self-tapping or sheet metal screws can be used to attach the tailgate cover to the tailgate.

As described herein, the present invention provides notable advantages over existing/factor tailgate covers. The tailgate cover system of the present invention provides a flat and durable padded layer supported by a rigid panel to provide a comfortable surface to kneel and/or sit on for accessing the bed of a truck. The tailgate cover system also provides a flat working surface. The tailgate cover system can also include cup holders to stably hold drinks.

### Broad Scope of the Invention

While illustrative embodiments of the invention have been described herein, the present invention is not limited to the various preferred embodiments described herein, but includes any-and-all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.” The use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. Additionally, the disclosure of ranges is intended as a continuous range including every value between the minimum and maximum values plus the broadening of the range afforded by the use of the term “about”, “substantially”, or “approximately.” Thus, recitation of ranges of values herein are merely intended to serve as a shorthand method of referring individually to each separate value falling within the range, unless otherwise indicated herein, and each separate value is incorporated into the specification as if it were individually recited herein. It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

What is claimed is:

1. A vehicle tailgate cover system, comprising:
a base of rigid material, the base having a front surface that is substantially flat, and the base including at least one mounting through-hole for mounting the vehicle tailgate cover system to a vehicle tailgate with fasteners, and
a padding layer attached to the base at the front surface of the base.

2. The vehicle tailgate cover system of claim 1, wherein the padding layer includes at least one through-hole and the at least one through hole of the padding layer is aligned with the least at least one mounting through-hole of the base.

3. The vehicle tailgate cover system of claim 1, wherein at least one of the at least one mounting through-hole of the base is located at an edge of the base, and the edge of the base is not covered by the padding layer to allow for fastening of the base between a lip of the vehicle tailgate and the vehicle tailgate.

4. The vehicle tailgate cover system of claim 1, further comprising a notch formed in the base and padding layer for allowing exposure of a component of the tailgate.

5. The vehicle tailgate cover system of claim 1, wherein the padding layer is attached to the base with an adhesive.

6. The vehicle tailgate cover system of claim 1, further comprising:
a cup holder through-hole extending through the padding layer and the base, and
a cup holder fitted in the cup holder through-hole.

7. The vehicle tailgate cover system of claim 1, wherein the base has a thickness of about ⅛ inch to about ¾ inch.

8. The vehicle tailgate cover system of claim 1, wherein the padding layer has a thickness of about 1/16 inch to about 1 inch.

9. The vehicle tailgate cover system of claim 1, wherein the base is made of a material selected from the group consisting of metal, plastic, polymer, fiberglass, and combinations thereof.

10. The vehicle tailgate cover system of claim 1, wherein the base is made of a material selected from the group consisting of aluminum, steel, stainless steel, and combinations thereof.

11. The vehicle tailgate cover system of claim 1, wherein the padding layer is made of material selected from the group consisting of foam, rubber, polymer, and combinations thereof.

12. The vehicle tailgate cover system of claim 1, wherein the padding layer is made of cross-linked polyethylene or marine-grade foam.

13. The vehicle tailgate cover system of claim 1, wherein the padding layer is in multiple pieces attached to the base.

14. The vehicle tailgate cover system of claim 1, wherein the padding layer includes a portion of reduced thickness at an edge for allowing closure of the tailgate.

15. A method of making a vehicle tailgate cover system, comprising:
providing a base of rigid material, the base having a front surface that is substantially flat, and the base having at least one mounting through-hole for mounting the vehicle tailgate cover system to a vehicle tailgate with fasteners,
providing a padding layer, and
attaching the padding layer to the base at the front surface of the base.

16. A method of using the vehicle tailgate cover system of claim 1, comprising:
aligning the at least one mounting through-hole of the base with mounting holes in a vehicle tailgate, and
fixing the vehicle tailgate cover system to the vehicle tailgate using fasteners inserted in the mounting through-holes of the base and the mounting holes of the vehicle tailgate.
